(19) United States
(12) Patent Application Publication
(10) Pub. No.: US 2009/0125641 A1
(43) Pub. Date: May 14, 2009

(54) Method and Apparatus for Managing an Olfactory Device

(76) Inventors: Zachary Adam Garbow, Rochester, MN (US); Candace Trielle Pederson, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/937,529

(22) Filed: Nov. 9, 2007

(51) Int. Cl. G06F 13/00

(52) U.S. Cl. 710/5

(57) ABSTRACT

One embodiment of a method for managing a scent dispensing request made to an olfactory display includes applying one or more filtering criteria to the request and determining whether to provide the request to the olfactory display for fulfillment, in accordance with the filtering criteria. In another embodiment, a system for dispensing scents in response to requests issued by one or more applications running on a computing device includes a filter for determining, in accordance with one or more criteria, which of the requests should be fulfilled and an olfactory display for dispensing at least one scent based on a determination made by the filter.

### FIELD OF THE INVENTION

The invention relates generally to olfactory displays and relates more particularly to controlling the dispensing of scents by an olfactory display.

### BACKGROUND OF THE INVENTION

An olfactory display is an output device that dispenses scents in response to commands issued by a coupled computing device. To this end, an olfactory display contains cartridges of basic chemical compounds (“primary odors”) that can be released in combinations via a dispersion mechanism in order to produce various recognizable scents. Thus, scents can be released, for example, in connection with applications running on the computing device (e.g., videos, email messages, advertisements, or the like) in order to enhance the effects of the applications.

One shortcoming of conventional olfactory displays is the inability to effectively control the dispensing of requested scents. Because scents are dispensed on demand in response to application requests, competing and constant requests may create scent conflicts. For example, by dispensing two or more scents in close proximity, the multiple scents may negate each other's effectiveness, or may in combination create an unpleasant or unintended scent. Alternatively, certain individual scents may simply be deemed unpleasant by a user, or may trigger allergic reaction in the user. Moreover, because scents are produced by resources that are in limited supply (i.e., cartridges), the inability to effectively control the dispensing of requested scents may result in waste (e.g., on scents that are deemed unpleasant or not worth the cost of chemicals), ultimately costing the user more money than is necessary.

Thus, there is a need in the art for a method and apparatus for dispensing scents in an olfactory display.

### SUMMARY OF THE INVENTION

One embodiment of a method for managing a scent dispensing request made to an olfactory display includes applying one or more filtering criteria to the request and determining whether to provide the request to the olfactory display for fulfillment, in accordance with the filtering criteria.

In another embodiment, a system for dispensing scents in response to requests issued by one or more applications running on a computing device includes a filter for determining, in accordance with one or more criteria, which of the requests should be fulfilled and an olfactory display for dispensing at least one scent based on a determination made by the filter.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a high level block diagram illustrating one embodiment of a filter for managing scent requests in an olfactory display, according to the present invention;

FIG. 2 is a flow diagram illustrating one embodiment of a method for managing scent requests in an olfactory display, according to the present invention;

FIG. 3 is a flow diagram illustrating a first embodiment of a method for applying filtering criteria to a request to dispense a scent, according to the present invention;

FIG. 4 is a flow diagram illustrating a second embodiment of a method for applying filtering criteria to a request to dispense a scent, according to the present invention;

FIG. 5 is a flow diagram illustrating a third embodiment of a method for applying filtering criteria to a request to dispense a scent, according to the present invention;

FIG. 6 is a flow diagram illustrating one embodiment of a method for generating recommendations for resource budgeting; and

FIG. 7 is a high level block diagram of the present invention implemented using a general purpose computing device.

To facilitate understanding, identical reference numerals have been used, where possible, to designate identical elements that are common to the figures.

### DETAILED DESCRIPTION

This invention relates to method and apparatus for dispensing scents in an olfactory display. Embodiments of the invention essentially filter incoming scent requests in accordance with one or more criteria, thereby making more effective use of resources such as cartridges. In one embodiment, the criteria that guide the filtering are configurable by a user.

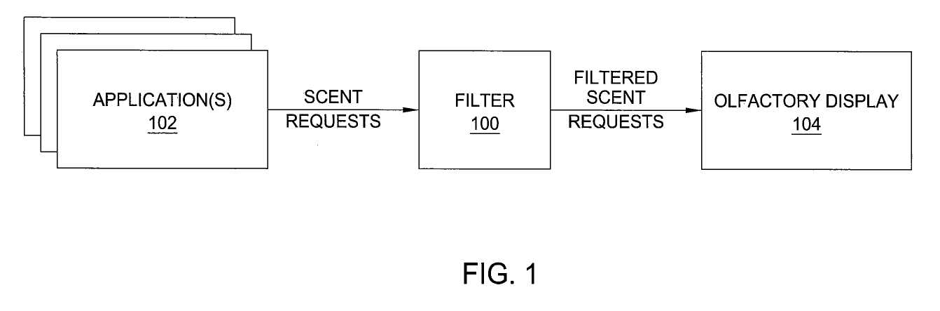

FIG. 1 is a high level block diagram illustrating one embodiment of a filter 100 for managing scent requests in an olfactory display 104, according to the present invention. As illustrated, the filter 100 resides between the olfactory display 104 and one or more applications 102 that request the dispensing of various scents by the olfactory display 104. The applications 102 run on a computing device (e.g., a desktop computer, a laptop computer, a personal digital assistant, a cellular telephone, a gaming console, a set top box, or the like) that is coupled to the olfactory display 104.

As illustrated, the filter 100 manages incoming scent requests from the applications 102, and filters the scent requests such that a subset of the incoming scent requests is provided to the olfactory display 104 for fulfillment. As will be discussed in further detail below, the filtering is in one embodiment performed in accordance with one or more criteria (e.g., budget, priority, conflict, user preference, etc.). In one embodiment, at least some of these criteria are configurable by a user. In one embodiment, incoming scent requests that do not conform to these criteria are not provided to the olfactory display 104.

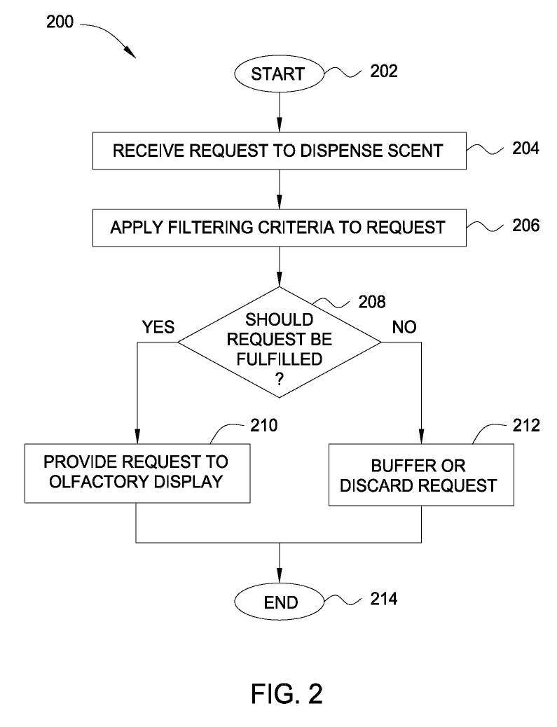

FIG. 2 is a flow diagram illustrating one embodiment of a method 200 for managing scent requests in an olfactory display, according to the present invention. The method 200 may be implemented, for example, as a filter (such as the filter 100 illustrated in FIG. 1) that manages incoming scent requests.

The method 200 is initialized at step 202 and proceeds to step 204, where the method 200 receives a request to dispense a scent. The request may be received, for example, from an application running on a computing device that is coupled to an olfactory display managed by the filter.

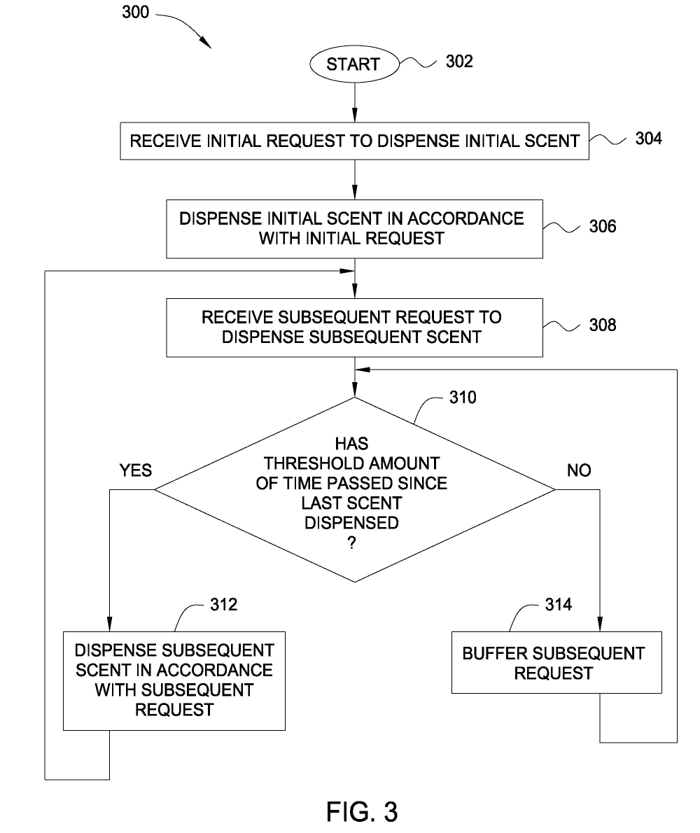

In step 206, the method 200 applies one or more filtering criteria to the received request. These filtering criteria guide the method 200 in determining which requests to dispense scents should be fulfilled. In one embodiment, at least one of the filtering criteria is configurable by a user of the olfactory display. In one embodiment, the filtering criteria relate to at least one of: a previous request to dispense a scent, an expected request to dispense a scent, a budget set by the user, preferences provided by the user, and an environment in which the olfactory display operates. Some specific embodiments for filtering a received request according to one or more criteria are discussed in greater detail with respect to FIGS. 3-5.

In step 208, the method 200 determines whether, based on application of the filtering criteria, the received request should be provided to the olfactory display for fulfillment. If the method 200 concludes in step 208 that the received request should be provided to the olfactory display for fulfillment, the method 200 provides the received request in step 210.

Alternatively, if the method 200 concludes in step 208 that the received request should not be provided to the olfactory display for fulfillment (at least, should not be provided for immediate fulfillment), the method 200 proceeds to step 212 and buffers or discards the received request, before terminating in step 214. The method 200 may buffer the received request if, for example, the received request is to be fulfilled but cannot be fulfilled immediately (e.g., some period of time must first pass or some event must first occur). The method 200 may discard the received request if, for example, the received request is never to be fulfilled. In one embodiment, a list of discarded requests is maintained so that a user may view the list and, if appropriate, manually select one or more requests for fulfillment.

FIG. 3 is a flow diagram illustrating a first embodiment of a method 300 for applying filtering criteria to a request to dispense a scent, according to the present invention. The method 300 may be implemented, for example, in conjunction with steps 206-208 of the method 200, discussed above. In particular, the method 300 may be implemented to reduce the occurrence of scent dispensing conflicts (e.g., where two or more scents dispensed in close proximity make it difficult for a user to discern any of the scents).

The method 300 is initialized at step 302 and proceeds to step 304, where the method 300 receives an initial request to dispense an initial scent. The request may be received, for example, from an application running on a computing device that is coupled to an olfactory display. In step 306, the method 300 dispenses the initial scent in accordance with the initial request.

In step 308, the method 300 receives a subsequent request to dispense a subsequent scent. The method 300 then proceeds to step 310 and determines whether a threshold amount of time has passed since the dispensing of the last dispensed scent (e.g., the initial scent dispensed in step 306). In one embodiment, the threshold amount of time is a predetermined amount that accounts for at least one of: the type of the last dispensed scent, the magnitude of the last dispensed scent, the type of the subsequent scent, and the size of the environment (e.g., room) into which the scents are released. The threshold amount of time is at least sufficiently long to allow the initial scent to be discerned by the user before a subsequent, potentially conflicting scent is dispensed.

If the method 300 concludes in step 310 that the threshold amount of time has passed since the dispensing of the last dispensed scent, the method 300 proceeds to step 312 and dispenses the subsequent scent in accordance with the subsequent request. The method 300 then returns to step 308 and awaits a new request to dispense a scent.

Alternatively, if the method 300 concludes in step 310 that the threshold amount of time has not passed since the dispensing of the last dispensed scent, the method 300 proceeds to step 314 and buffers the subsequent request until a sufficient amount of time has passed. Buffering of the subsequent request involves placing the subsequent request in a queue. In one embodiment, requests that are buffered in the queue are prioritized in accordance with some criteria (i.e., to determine the relative order of the requests in the queue). In a further embodiment, if the application making the subsequent request is closed before the subsequent scent is dispensed, then the subsequent request is expunged from the queue. In one embodiment, the user is notified of the buffering of the subsequent request.

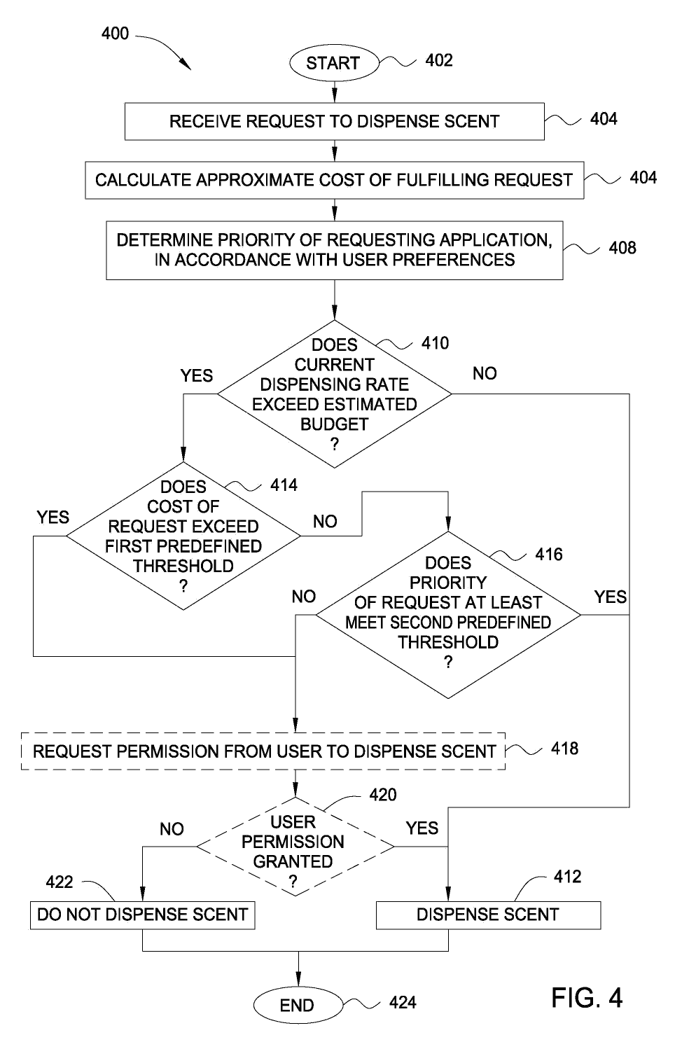

FIG. 4 is a flow diagram illustrating a second embodiment of a method 400 for applying filtering criteria to a request to dispense a scent, according to the present invention. The method 400 may be implemented, for example, in conjunction with steps 206-208 of the method 200, discussed above. In particular, the method 400 may be implemented to manage the dispensing of scent according to a budget, which may be user-configured. Because the dispensing of a scent uses a resource (chemical compound(s)), it may cost the user money each time a scent is dispensed. As such, the method 400 manages the dispensing of scents according to the amount of money or resources that the user is willing to afford to scent dispensing. In one embodiment, the budget specifies an upper limit on the amount of money to be spent over a given time period on dispensing scents (e.g., no more than x dollars per month).

The method 400 is initialized in step 402 and proceeds to step 404, where the method 400 receives a request to dispense a scent. The method 400 then proceeds to step 406 and calculates the approximate cost of fulfilling the received request (i.e., the cost of dispensing the scent). Since each scent comprises a combination of one or more base compounds, along with magnitudes of scent, different scents may cost different amounts of money to dispense.

In step 408, the method 400 determines the priority of the application making the request. In one embodiment, the priority of the application is dictated by user preferences. In one embodiment, requests are prioritized based on at least one of: a requesting application, a sender of a communication triggering a scent dispensing request, community ratings, scent categories, or inherited preferences (e.g., from friends). For instance, a user may give higher priority to communications (triggering scent dispensing requests) from a significant other or from a friend than to communications from random World Wide Web sites. As another example, email applications may be given higher priority than web browser applications. As a further example, higher priority may be given to World Wide Web sites whose scents have received a threshold positive rating from a relevant community of users. As a further example still, higher priority may be given to scent categories that a user deems desirable (e.g., “floral”) than to scent categories that the user deems undesirable (e.g., “food”). As yet another example, a user may give higher priority to scents that are highly ranked by his or her friends. Any of these priority criteria may be used not just to block or allow certain scent requests, but to arrange buffered scent requests in a relative order in a queue.

In step 410, the method 400 determines whether the current scent dispensing rate exceeds an estimated budget. That is, by analyzing the user's scent request history, the method 400 can estimate how many scent dispensing requests can be fulfilled during a given time period and in accordance with the budget.

If the method 400 concludes in step 410 that the current scent dispensing rate does not exceed the estimated budget, the method 400 proceeds to step 412 and dispenses scent requested in step 404 before terminating in step 424.

Alternatively, if the method 400 concludes in step 410 that the current scent dispensing rate exceeds the estimated budget, the method 400 proceeds to step 414 and determines whether the approximate cost of the request (e.g., as calculated in step 406) exceeds a first predefined threshold (i.e., whether the request is “too expensive” to fulfill as required).

If the method 400 concludes in step 414 that the approximate cost of the request does not exceed the first predefined threshold (is not “too expensive”), the method 400 proceeds to step 412 and dispenses scent requested in step 404 before terminating in step 424.

Alternatively if the method 400 concludes in step 414 that the approximate cost of the request exceeds the first predefined threshold (is “too expensive”), the method 400 proceeds to step 416 and determines whether the priority of the request (e.g., as calculated in step 408) at least meets a second predefined threshold (i.e., whether the priority of the request is “high enough”). If the method 400 concludes in step 416 that the priority of the request at least meets the second predefined threshold (is “high enough”), the method 400 proceeds to step 412 and dispenses scent requested in step 404 before terminating in step 424. In one embodiment, if the priority of the request is relatively high, but the budget is nearly expended, the method 400 dispenses the requested scent, but in a weaker concentration than would normally be dispensed.

Alternatively if the method 400 concludes in step 416 that the priority of the request does not at least meet the second predefined threshold (is not “high enough”), the method 400 proceeds to step 422 and declines to dispense the scent requested in step 404 before terminating in step 424.

Thus, if the current scent dispensing rate appears as if it may exceed the budget, the method 400 prioritizes incoming requests to dispense scents according to the costs and/or priorities of the requests, filtering out those requests that are deemed “expensive” or “low priority” and giving weight to “less expensive” and “higher priority” requests.

Optionally, even if a request is deemed to be “expensive” or “low priority”, the method 400 may request user permission to fulfill the request, rather than automatically filter out the request. In this case, once the request is deemed not to satisfy the first threshold or second threshold (i.e., in accordance with steps 414 and 416), the method 400 proceeds to optional step 418 (illustrated in phantom) and requests permission from the user to dispense the requested scent.

In optional step 420 (illustrated in phantom), the method 400 determines whether user permission to dispense the requested scent has been granted. If the method 400 concludes in step 410 that user permission has been granted, the method 400 proceeds to step 412 and dispenses the scent requested in step 404 before terminating in step 424. Alternatively, if the method 400 concludes in step 420 that user permission has not been granted, the method 400 proceeds to step 422 and declines to dispense the scent requested in step 404 before terminating in step 424.

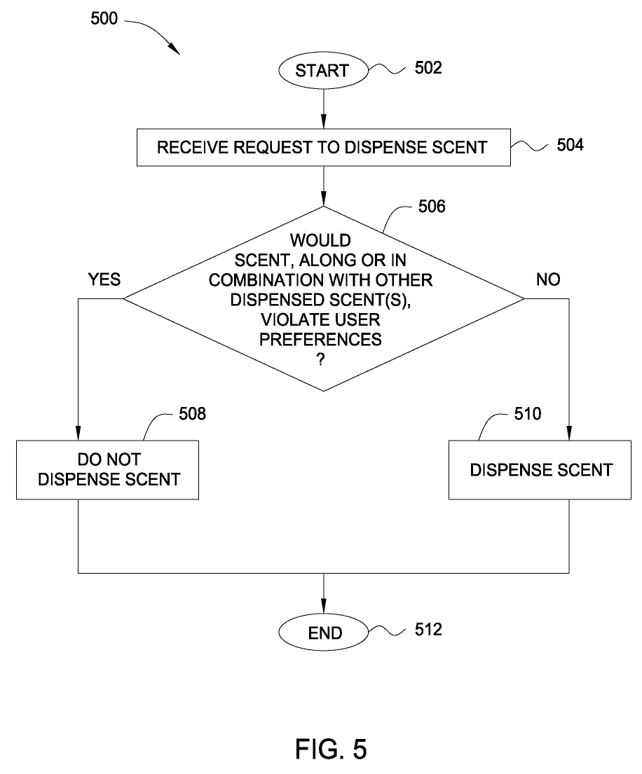

FIG. 5 is a flow diagram illustrating a third embodiment of a method 500 for applying filtering criteria to a request to dispense a scent, according to the present invention. The method 500 may be implemented, for example, in conjunction with steps 206-208 of the method 200, discussed above. In particular, the method 500 may be implemented to manage the dispensing of scent to avoid the production of unpleasant scents, the identification of which may be user-configured.

The method 500 is initialized at step 502 and proceeds to step 504, where the method 500 receives a request to dispense a scent. In step 506, the method 500 determines whether dispensing of the requested scent, alone or in combination with other previously dispensed (and possibly lingering) scents, would violate user preferences. In one embodiment, the user preferences identify scents or scent combinations that the user finds unpleasant or otherwise offensive (e.g., likely to cause an allergic reaction).

If the method 500 concludes in step 506 that dispensing the requested scent, alone or in combination with other previously dispensed scents, would violate user preferences, the method 500 proceeds to step 508 and declines (at least temporarily) to dispense the scent. In one embodiment, the method 500 discards the request received in step 504. In another embodiment, the method 500 buffers the request received in step 504 until a time at which the requested scent can be dispensed without violating the user preferences (e.g., when a previously dispensed scent has dissipated). The method 500 then terminates in step 512.

Alternatively if the method 500 concludes in step 506 that dispensing the requested scent, alone or in combination with other previously dispensed scents, would not violate user preferences, the method 500 proceeds to step 510 dispenses the scent before terminating in step 512.

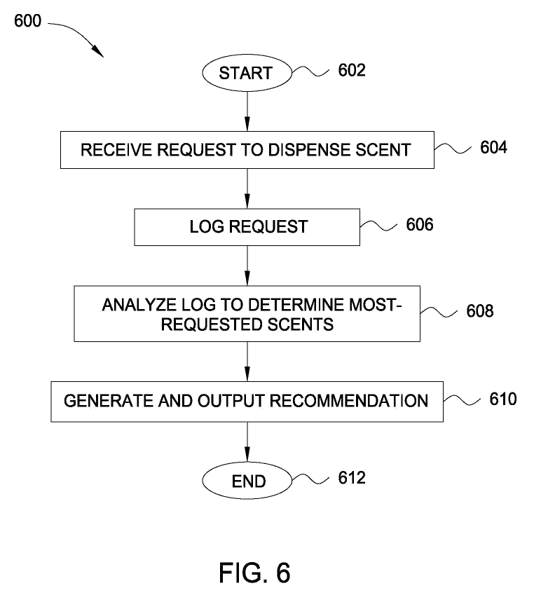

FIG. 6 is a flow diagram illustrating one embodiment of a method 600 for generating recommendations for resource budgeting. The method 600 may be implemented, for example, at the filter 100 of FIG. 1, in order to provide a user with recommendations for olfactory display resource budgeting. For instance, while there are a great number of primary odors (e.g., 100+) that can be used in combination to create most other scents, it is contemplated that the cost of deploying an individual cartridge for each of these primary odors would be prohibitive for most users. However, a small subset of these primary odors may be sufficient to create the scents that a user requires most often. This subset will likely vary from user to user.

The method 600 is initialized at step 602 and proceeds to step 604, where the method 600 receives a request to dispense a scent. In step 606, the method 600 logs the request. In one embodiment, the log comprises, for each request, a “scent fingerprint” of the scent that was requested. This fingerprint includes at least an identifier for the requested scent (e.g., “floral”) and identifiers for the primary odors required to create the requested scent (e.g., primary odors a, b, and c). In one embodiment, the method 600 logs the request regardless of whether the request is actually fulfilled (i.e., even requests that are ultimately filtered out are logged).

In step 608, the method 600 analyzes the log to determine the most-requested scents. In one embodiment, analysis in accordance with step 608 further involves deconstructing the “scent fingerprints” contained in the log and aggregating the results in order to identify the primary odors that are most frequently required based on the requested scents. In one embodiment, the method identifies the N-most required primary odors, where N represents a number of primary odors and may be configurable by the user. In one embodiment, the analysis in accordance with step 608 is performed in response to a request from the user to generate a budgeting recommendation.

In step 610, the method generates and outputs a budgeting recommendation, based on the analysis performed in step 608. In one embodiment, the recommendation comprises a list of the N-most required primary odors. These primary odors represent the cartridges that the user should deploy in order to achieve fulfillment of most of his or her scent requests, based on the request history.

In a further embodiment of the method 600, a log entry for a scent further includes one or more applications, files, or World Wide Web sites that are viewed during a time period in which the associated scent is expected to be discernible by the user. Among other applications, this allows the user to later search for files or World Wide Web sites using scent as a search parameter (e.g., such that if a scent is specified as a search parameter, a search engine may use the log entry to search among the applications, files, and World Wide Web sites that were viewed during the time that the specified scent was discernible). This allows a user to exploit the well-known link between sense of smell and human memory.

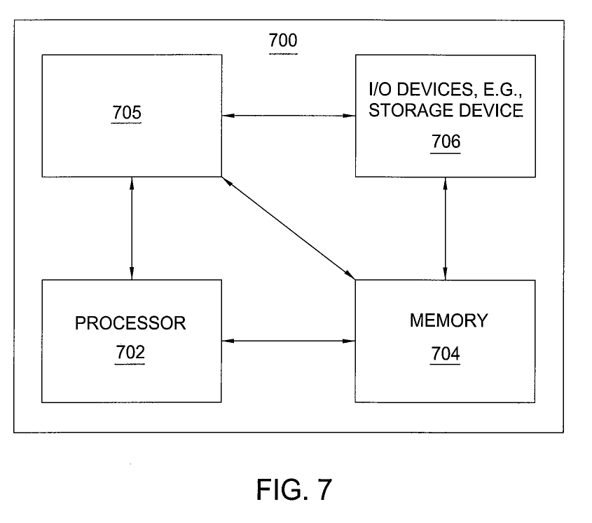

FIG. 7 is a high level block diagram of the present invention implemented using a general purpose computing device 700. It should be understood that the request filtering engine, manager or application (e.g., for allocating resources among threads) can be implemented as a physical device or subsystem that is coupled to a processor through a communication channel. Therefore, in one embodiment, a general purpose computing device 700 comprises a processor 702, a memory 704, a request filtering module 705 and various input/output (I/O) devices 706 such as a display, a keyboard, a mouse, a modem, and the like. In one embodiment, at least one I/O device is a storage device (e.g., a disk drive, an optical disk drive, a floppy disk drive).

Alternatively, the request filtering engine, manager or application (e.g., request filtering module 705) can be represented by one or more software applications (or even a combination of software and hardware, e.g., using Application Specific Integrated Circuits (ASIC)), where the software is loaded from a storage medium (e.g., I/O devices 706) and operated by the processor 702 in the memory 704 of the general purpose computing device 700. Thus, in one embodiment, the request filtering module 705 for managing scent dispensing requests made to an olfactory display described herein with reference to the preceding Figures can be stored on a computer readable medium or carrier (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

Although various embodiments which incorporate the teachings of the present invention have been shown and described in detail herein, those skilled in the art can readily devise other embodiments without departing from the basic scope of the present invention.

What is claimed is:

1. A method for managing a request made to an olfactory display, the request requesting that the olfactory display dispense a scent, the method comprising:
applying one or more filtering criteria to the request; and
determining whether to provide the request to the olfactory display for fulfillment, in accordance with the one or more filtering criteria.

2. The method of claim 1, further comprising:
providing the request to the olfactory display, if the request meets the one or more filtering criteria.

3. The method of claim 2, wherein the providing comprises:
placing the request in a queue, an order of requests in the queue being at least partially determined by the one or more filtering criteria.

4. The method of claim 3, further comprising:
providing the request to the olfactory display once the request reaches a head of the queue and the olfactory display is prepared to receive a new request.

5. The method of claim 1, further comprising:
discarding the request, if the request does not meet the one or more filtering criteria.

6. The method of claim 1, wherein the one or more filtering criteria relates to at least one of: a previous request to dispense a scent, an expected request to dispense a scent, a scent dispensing budget, a user preference, or an environment in which the olfactory display operates.

7. The method of claim 1, wherein at least one of the one or more filtering criteria is configurable by a user.

8. The method of claim 1, wherein the determining comprises:
assessing whether the scent, if dispensed, would conflict with a previously dispensed scent.

9. The method of claim 8, wherein the assessing comprises:
determining whether a threshold amount of time has passed since the previously dispensed scent was dispensed by the olfactory display.

10. The method of claim 9, further comprising:
providing the request to the olfactory display, if the threshold amount of time has passed; and
buffering the request, if the threshold amount of time has not passed.

11. The method of claim 9, wherein the threshold amount of time accounts for at least one of: a type of the previously dispensed, a magnitude of the previously dispensed, a type of the scent requested by the request, or a size of an environment in which the olfactory display operates.

12. The method of claim 1, wherein the determining comprises:
assessing whether fulfillment of the request would violate a scent dispensing budget.

13. The method of claim 12, wherein the assessing comprises:
calculating an approximate cost of fulfilling the request; and
providing the request to the olfactory display if the approximate cost does not exceed a predefined threshold.

14. The method of claim 12, wherein the assessing comprises:
determining a priority of the request; and
providing the request to the olfactory display if the priority at least meets a predefined threshold.

15. The method of claim 1, wherein the determining comprises:
determining whether dispensing the scent would violate a user preference.

16. The method of claim 1, further comprising:
creating an entry for the request in a request history log.

17. The method of claim 16, wherein the entry comprises at least one of: an identifier for the scent, one or more identifiers for one or more primary odors required to create the scent, and one or more applications, files, or World Wide Web sites viewed while the scent is discernible by a user.

18. The method of claim 16, further comprising:
identifying one or more primary odors most frequently required to create scents requested in the request history log; and
providing a user with a list of the one or more primary odors so identified.

19. A computer readable medium containing an executable program for managing a request made to an olfactory display, the request requesting that the olfactory display dispense a scent, where the program performs the steps of:
applying one or more filtering criteria to the request; and
determining whether to provide the request to the olfactory display for fulfillment, in accordance with the one or more filtering criteria.

20. A system for dispensing scents in response to requests issued by one or more applications running on a computing device, the system comprising:
a filter for determining, in accordance with one or more criteria, which of the requests should be fulfilled; and
an olfactory display for dispensing at least one scent based on a determination made by the filter.
